(19) United States
(12) Patent Application Publication
(10) Pub. No.: US 2024/0328981 A1
(43) Pub. Date: Oct. 3, 2024

(54) GAS SENSOR

(71) Applicant: TDK CORPORATION, Tokyo (JP)

(72) Inventors: Makoto SHIBATA, Tokyo (JP); Shizuko ONO, Tokyo (JP); Takumi MATSUO, Tokyo (JP)

(73) Assignee: TDK CORPORATION, Tokyo (JP)

(21) Appl. No.: 18/616,300

(22) Filed: Mar. 26, 2024

(30) Foreign Application Priority Data
Mar. 30, 2023 (JP) 2023-056005

(51) Int. Cl. G01N 27/16

(52) U.S. Cl. CPC G01N 27/16

(57) ABSTRACT

A gas sensor includes a gas detection part provided on an insulating film. The gas detection part includes a detector and an electrode in contact with the detector. The electrode includes an inner electrode portion and an outer electrode portion disposed so as to surround the inner electrode portion.

### CROSS-REFERENCE TO RELATED APPLICATIONS

The present application claims priority from Japanese Patent Application No. 2023-056005 filed on Mar. 30, 2023, the entire contents of which are hereby incorporated by reference.

### BACKGROUND

The present disclosure relates to a gas sensor.

Gas sensors can detect, for example, gas leakage and are installed in home appliances, industrial equipment, environmental monitoring equipment, etc. As described in Patent Document 1, a gas sensor includes: a detector whose physical characteristics change in accordance with the gas concentration in the atmosphere; and an electrode for outputting the change in physical characteristics as an electrical signal. When the physical characteristics of the detector change in accordance with a change in gas concentration, the electrical signal output from the electrode fluctuates. Based on the fluctuation value of this electrical signal, it is possible to determine the gas concentration, etc.

By the way, the gas concentration distribution or the gas flow direction in the atmosphere is constantly varying due to movement of people or objects, weather changes, etc. It is found that, in a conventional gas sensor as shown, for example, in Patent Document 1, noise is superimposed on the electrical signal output from the electrode due to variations in the gas concentration distribution or gas flow direction, which may result in a decrease in detection accuracy, responsiveness, etc. of the gas sensor.
Patent Document 1: JP6917843 (B2)

### SUMMARY

A gas sensor according to the present disclosure is a gas sensor comprising a gas detection part provided on an insulating film, wherein
the gas detection part includes:
   a detector; and
   an electrode in contact with the detector, and
the electrode includes:
   an inner electrode portion; and
   an outer electrode portion disposed so as to surround the inner electrode portion.

### BRIEF DESCRIPTION OF THE DRAWING(S)

FIG. 1 is a schematic plan view of a gas sensor according to First Embodiment of the present disclosure;

FIG. 2 is a cross-sectional view of the gas sensor shown in FIG. 1 along the line II-II;

FIG. 3 is a partially enlarged plan view around the center of the gas sensor shown in FIG. 1;

FIG. 4 is a partially enlarged plan view around the center of the gas sensor shown in FIG. 2;

FIG. 5A is a plan view of a substrate shown in FIG. 2;

FIG. 5B is a plan view of a first insulating film shown in FIG. 2;

FIG. 5C is a plan view of a heating part shown in FIG. 2;

FIG. 5D is a plan view of a second insulating film shown in FIG. 2;

FIG. 5E is a plan view of an inner electrode portion shown in FIG. 2;

FIG. 5F is a plan view of a third insulating film shown in FIG. 2;

FIG. 5G is a plan view of a thermistor film shown in FIG. 2;

FIG. 5H is a plan view of an outer electrode portion shown in FIG. 2;

FIG. 5I is a plan view of terminals shown in FIG. 1;

FIG. 5J is a plan view of a catalyst shown in FIG. 2;

FIG. 6A is a schematic partially-enlarged plan view of a gas sensor according to Second Embodiment of the present disclosure;

FIG. 6B is a cross-sectional view of the gas sensor shown in FIG. 6A along the line VIB-VIB;

FIG. 7A is a schematic partially-enlarged plan view of a gas sensor according to Third Embodiment of the present disclosure;

FIG. 7B is a cross-sectional view of the gas sensor shown in FIG. 7A along the line VIIB-VIIB;

FIG. 8A is a schematic partially-enlarged plan view of a gas sensor according to Fourth Embodiment of the present disclosure;

FIG. 8B is a cross-sectional view of the gas sensor shown in FIG. 8A along the line VIIIB-VIIIB;

FIG. 9A is a schematic partially-enlarged plan view of a gas sensor according to Fifth Embodiment of the present disclosure;

FIG. 9B is a cross-sectional view of the gas sensor shown in FIG. 9A along the line IXB-IXB;

FIG. 10 is a diagram showing a response waveform of a gas sensor of Example; and

FIG. 11 is a diagram showing a response waveform of a gas sensor of Comparative Example.

### DETAILED DESCRIPTION

Hereinafter, embodiments of the present disclosure are described with reference to figures. Note that, the illustrated contents are merely shown schematically and exemplarily for understanding the present disclosure and may be different from actual one in terms of appearance, dimensional ratio, etc. Moreover, the present disclosure is not limited to the following embodiments.

### First Embodiment

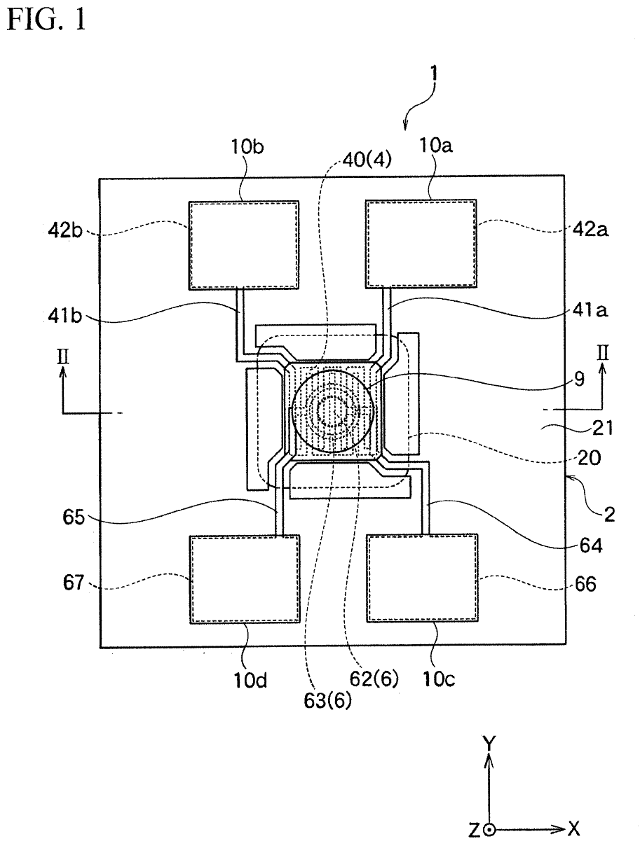

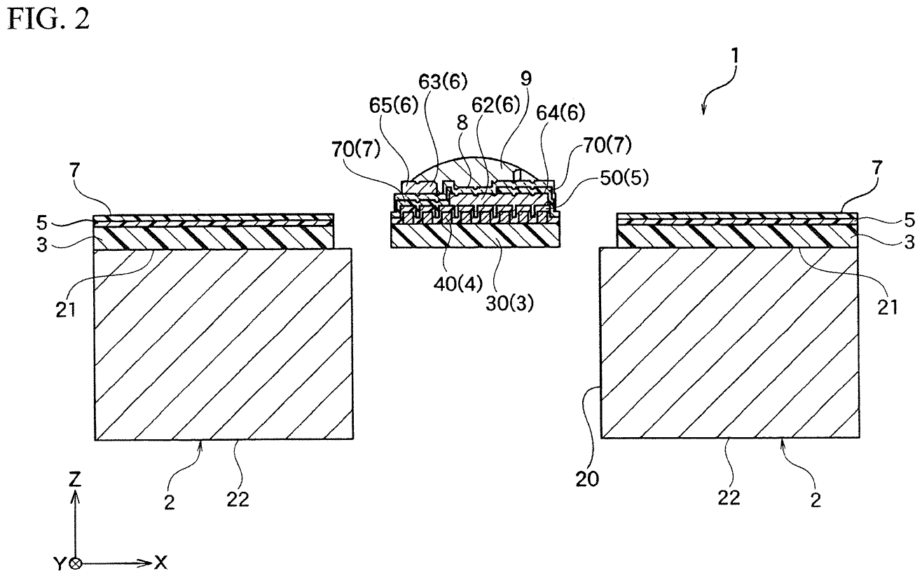

A gas sensor 1 according to First Embodiment of the present disclosure shown in FIG. 1 and FIG. 2 is a device for detecting, for example, gas leakage and is installed in home appliances, industrial equipment, environmental monitoring equipment, etc. The gas sensor 1 is a contact-combustion-type gas sensor and detects gases such as CO, H₂, CH₄ and C₂H₅OH. The gas sensor 1 may be a thermal-conduction-type gas sensor and may detect gases such as CO₂, H₂, H₂O (water vapor) and CH₄.

The gas sensor 1 includes, for example, a substrate 2, a first insulating film 3, a heating part 4, a second insulating film 5, an electrode 6, a third insulating film 7, a detector 8, and a catalyst 9, and terminals 10a to 10d. However, the structure of the gas sensor 1 is not limited to the structure shown in FIG. 1, FIG. 2, etc. and may be modified as appropriate without departing from the scope of the present disclosure.

In FIG. 1, FIG. 2, etc., the X-axis and the Y-axis are axes corresponding to two orthogonal sides of the substrate 2, and the Z-axis is an axis orthogonal to the X-axis and the Y-axis. Hereinafter, for each of the X-axis, Y-axis, and Z-axis, the direction toward the center of the substrate 2 is defined as “inside”, and the direction away from the center of the substrate 2 is defined as “outside”. For the Z-axis, one side (positive side) is defined as “upper”, and the other side (negative side) is defined as “lower”.

As shown in FIG. 1 and FIG. 2, the substrate 2 includes a cavity 20 formed by etching, etc. The substrate 2 is made of, for example, a material that has a mechanical strength capable of supporting the insulating films (the first insulating film 3, etc.) and is favorable for microfabrication such as etching. The material constituting the substrate 2 is not limited and is, for example, a silicon single crystal substrate, a sapphire single crystal substrate, a ceramic substrate, a quartz substrate, a glass substrate, or the like. The shape of the substrate 2 is square in plan view, but may be circular, oval, oblong, another polygon, or the like.

The cavity 20 is formed in a central part of the substrate 2 and penetrates the substrate 2 along the Z-axis. The shape of the cavity 20 is square in plan view, but may be circular, elliptical, oblong, another polygon, or the like. A plurality (four in the example shown in FIG. 1) of curved portions is formed on the outer edge of the cavity 20, but the curved portions may be omitted. The cavity 20 in the present embodiment is a through hole, but may also be a recess recessed from a top surface 21 toward a bottom surface 22 of the substrate 2.

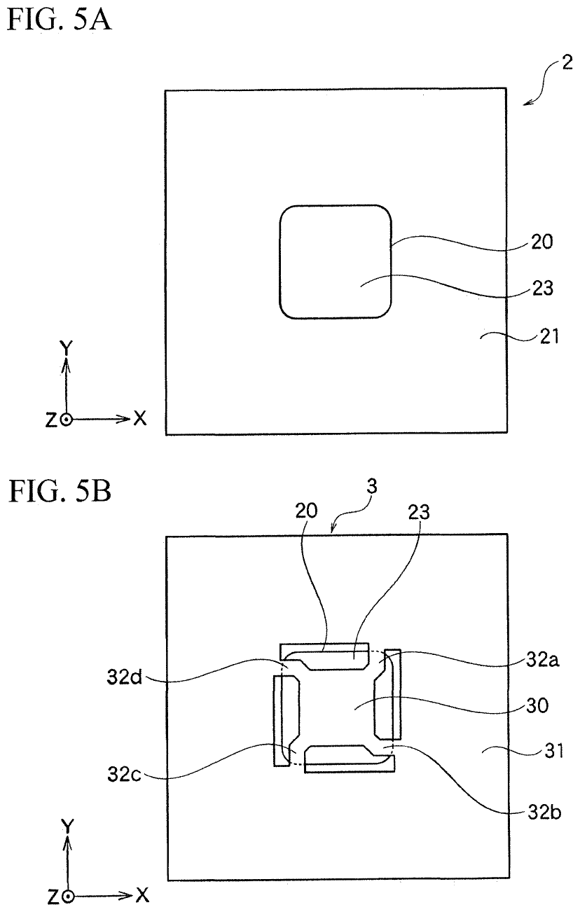

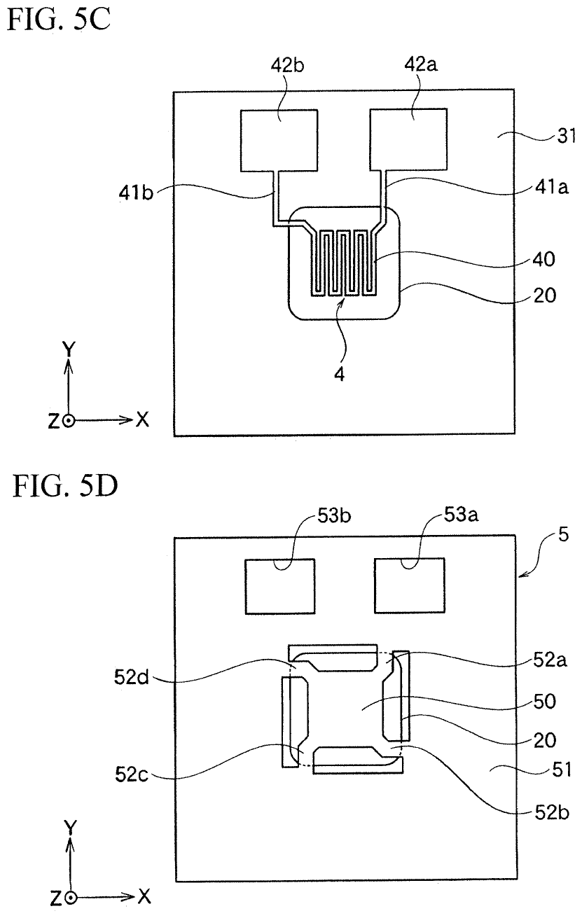

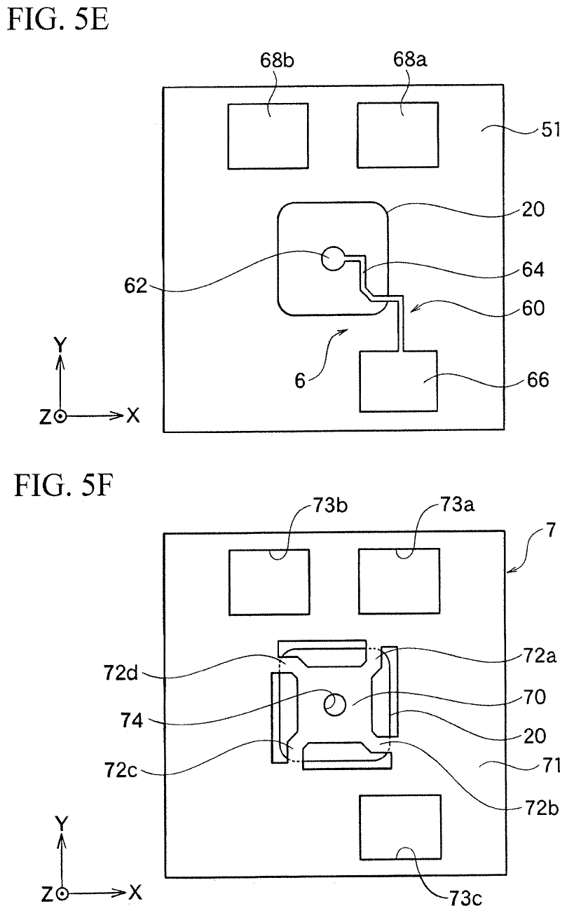

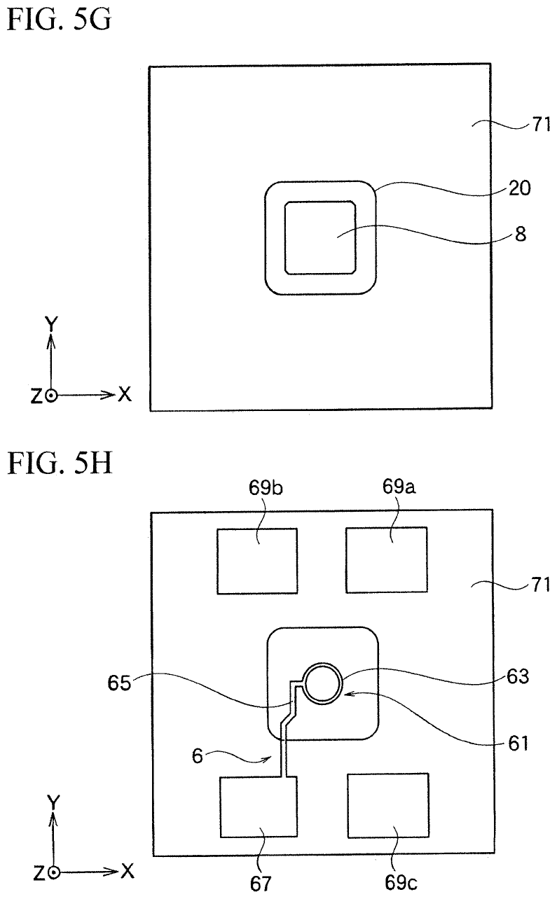

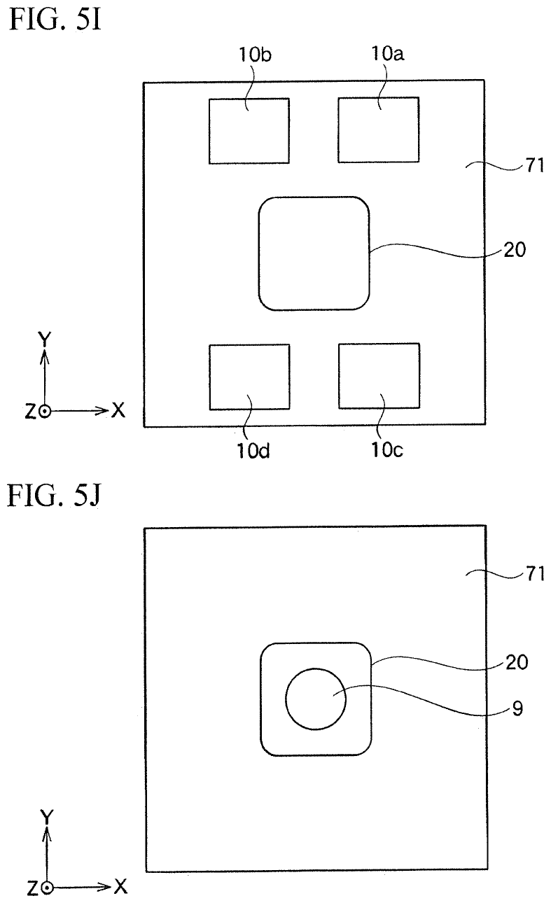

As shown in FIG. 5A, the top surface 21 of the substrate 2 has a quadrangular ring shape and is formed along the outer edge of the cavity 20. Although not illustrated in detail, the bottom surface 22 of the substrate 2 has a quadrangular ring shape and is formed along the outer edge of the cavity 20.

As shown in FIG. 2, the first insulating film 3 is made of an insulating material and is formed on the top surface 21 of the substrate 2. As shown in FIG. 5B, the first insulating film 3 has a film structure and is manufactured by a known film forming method (sputtering method, CVD method, thermal oxidation method, etc.). The material constituting the first insulating film 3 is not limited and is, for example, silicon oxide, silicon nitride, or the like. The first insulating film 3 may be a single-layer film or a multilayer film. The thickness of the first insulating film 3 is not limited and is, for example, 0.1 to 3.0 μm. The shape of the first insulating film 3 is obtained by, for example, etching (patterning). The first insulating film 3 includes a first base portion 30, a first peripheral portion 31, and first beam portions 32a to 32d.

The first base portion 30 is located inside an opening edge of the cavity 20 (an inner edge of the top surface 21 shown in FIG. 5A) and is disposed along an opening portion 23 of the cavity 20. A gap is locally formed between the first base portion 30 and the opening edge of the cavity 20. The shape of the first base portion 30 is square in plan view, but may be circular, elliptical, oblong, another polygon, or the like.

The first peripheral portion 31 is disposed on the top surface 21 (FIG. 5A) of the substrate 2. The shape of the first peripheral portion 31 corresponds to the shape of the top surface 21 and has a quadrangular ring shape in plan view. The first peripheral portion 31 is disposed outside the first base portion 30 so as to surround the first base portion 30.

The beam (bridge) portions 32a to 32d are located between the first base portion 30 and the first peripheral portion 31 and bridge the first base portion 30 and the first peripheral portion 31. The beam portions 32a to 32d are arranged along the opening portion 23 of the cavity 20. The beam portions 32a to 32d are connected to the four corners of the first base portion 30 and extend while being bent. However, the positions and shapes of the beam portions 32a to 32d are not limited to the positions and shapes shown in FIG. 5B. The beam portions 32a to 32d support the first base portion 30 so that the first base portion 30 is disposed in the opening portion 23. The number of beam portions 32a to 32d is four, but the number of beam portions 32a to 32d is not limited to this.

As shown in FIG. 2, the heating part 4 is formed on the first insulating film 3. The heating part 4 is for increasing the temperature of the detector 8 to a predetermined temperature (operating temperature). The heating part 4 has a film structure and is manufactured by a known film forming method. The shape of the heating part 4 is obtained by, for example, a lift-off method. Note that, in the lift-off method, a predetermined pattern is formed on a patterning surface as follows. First, a resist is applied to the patterning surface. Next, the resist is exposed and developed. Next, a film made of a pattern material is formed by sputtering, vapor deposition, etc. And then, an unnecessary part of the film and the resist are peeled off.

The heating part 4 is made of, for example, a conductive material having a comparatively high melting point. The material constituting the heating part 4 is not limited and is, for example, molybdenum, platinum, nickel, chromium, tungsten, tantalum, palladium, iridium, or an alloy containing one or more of these elements. Among them, platinum, which has a high corrosion resistance, is preferable. When the heating part 4 is made of platinum, an adhesion layer made of titanium, etc. may be formed between the first insulating film 3 and the heating part 4. As shown in FIG. 5C, the heating part 4 includes a heat generation portion 40, heater leading portions 41a and 41b, and heater terminal portions 42a and 42b.

The heat generation portion 40 has a meander pattern and is disposed on the first base portion 30 (FIG. 2) of the first insulating film 3. Since the heat generation portion 40 has a meandering pattern, the detector 8 can be heated uniformly. Since the gas sensor 1 has an air bridge structure, the electric power consumption of the heating part 4 can be reduced at the time of heating the detector 8.

The heater leading portion 41a is connected to one end of the heat generation portion 40, and the heater leading portion 41b is connected to the other end of the heat generation portion 40. The heater leading portion 41a is led out to the first peripheral portion 31 via the beam portion 32a on the first insulating film 3 (FIG. 5B). The heater leading portion 41b is led out to the first peripheral portion 31 via the beam portion 32d on the first insulating film 3 (FIG. 5B).

The heater terminal portion 42a is connected to the heater leading portion 41a, and the heater terminal portion 42b is connected to the heater leading portion 41b. The heater terminal portions 42a and 42b are arranged on the first peripheral portion 31 (FIG. 5B) of the first insulating film 3. The shape of each of the heater terminal portions 42a and 42b is oblong in plan view, but may be circular, elliptical, square, another polygon, or the like. The heater terminal portions 42a and 42b are terminals for supplying electric power to the heat generation portion 40.

As shown in FIG. 2, the second insulating film 5 is laminated on the first insulating film 3. For more detail, the second insulating film 5 is disposed on the first insulating film 3 so that the heating part 4 (FIG. 5C) is interposed between the first insulating film 3 and the second insulating film 5. The material and manufacturing method of the second insulating film 5 are the same as the material and manufacturing of the first insulating film 3, but may be different from the material and manufacturing of the first insulating film 3. Also, the second insulating film 5 may be a single-layer film or a multilayer film. As shown in FIG. 5D, the second insulating film 5 includes a second base portion 50, a second peripheral portion 51, second beam portions 52a to 52d, and second hole portions 53a and 53b.

The second base portion 50 has the same structure as the first base portion 30 (FIG. 5B) and is disposed on the first base portion 30. The heat generation portion 40 (FIG. 5C) is disposed between the first base portion 30 and the second base portion 50. The second peripheral portion 51 has the same structure as the first peripheral portion 31 (FIG. 5B) and is disposed on the first peripheral portion 31.

The second beam portions 52a to 52d have the same structure as the first beam portions 32a to 32d (FIG. 5B) and are arranged on the first beam portions 32a to 32d. The heater leading portion 41a (FIG. 5C) is disposed between the first beam portion 32a and the second beam portion 52a, and the heater leading portion 41b is disposed between the first beam portion 32d and the second beam portion 52d. The second hole portions 53a and 53b penetrate the second peripheral portion 51 and are formed at positions corresponding with the heater terminal portions 42a and 42b (FIG. 5C), respectively.

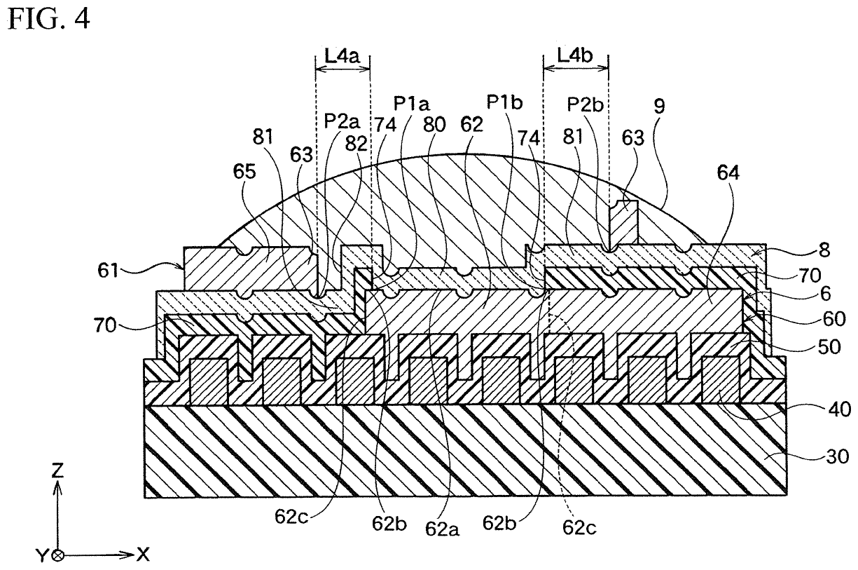

As shown in FIG. 4, a lower electrode layer 60 is formed on the second insulating film 5 (second base portion 50, etc.). The lower electrode layer 60 constitutes the electrode 6 together with an upper electrode layer 61 described below. The electrode 6 is for outputting a change in the physical characteristics (resistance value) of the detector 8 as an electrical signal. The lower electrode layer 60 has a film structure and is manufactured by a known film forming method.

The lower electrode layer 60 (the same applies to the upper electrode layer 61) is made of, for example, a conductive material having a comparatively high melting point). The material constituting the lower electrode layer 60 (the same applies to the upper electrode layer 61) is not limited and is, for example, molybdenum, platinum, gold, tungsten, tantalum, palladium, iridium, or an alloy containing one or more of these elements. As shown in FIG. 5E, the lower electrode layer 60 includes an inner electrode portion 62, an inner leading portion 64, an inner terminal portion 66, and lower conductive paths 68a and 68b.

The inner electrode portion 62 is disposed on the second base portion 50 (FIG. 5D). The detailed structure of the inner electrode portion 62 is described below. The inner leading portion 64 is connected to the inner electrode portion 62 and led out from the second base portion 50 to the second peripheral portion 51 via the beam portion 52b (FIG. 5D).

The inner terminal portion 66 is connected to the inner leading portion 64 and is disposed on the second peripheral portion 51 (FIG. 5D). The shape of the inner terminal portion 66 is oblong in plan view, but may be circular, elliptical, square, another polygon, or the like.

The lower conductive path 68a has the same shape as the heater terminal portion 42a (FIG. 5C) and is disposed on the heater terminal portion 42a via the second hole portion 53a (FIG. 5D). The lower conductive path 68a is electrically and physically connected to the heater terminal portion 42a. The lower conductive path 68b has the same shape as the heater terminal portion 42b (FIG. 5C) and is disposed on the heater terminal portion 42b via the second hole portion 53b (FIG. 5D). The lower conductive path 68b is electrically and physically connected to the heater terminal portion 42b.

As shown in FIG. 2, the third insulating film 7 is laminated on the second insulating film 5. For more detail, the third insulating film 7 is disposed on the second insulating film 5 so that the lower electrode layer 60 is interposed between the second insulating film 5 and the third insulating film 7. The material and manufacturing method of the third insulating film 7 are the same as the material and manufacturing method of the second insulating film 5, but may be different from the material and manufacturing method of the second insulating film 5. The third insulating film 7 may be a single-layer film or a multilayer film. When the first insulating film 3, the second insulating film 5, and the third insulating film 7 are made of the same material, the adhesion at each interface of the insulating films is improved, and the mechanical strength of each insulating film is ensured. When at least one of the first insulating film 3, the second insulating film 5, and the third insulating film 7 is made of a different material, the lamination of the different material reduces film stress and can form a stable laminated body of the insulating films. As shown in FIG. 5F, the third insulating film 7 includes a third base portion 70, a third peripheral portion 71, third beam portions 72a to 72d, third hole portions 73a to 73c, and a base hole portion 74.

The third base portion 70 has the same structure as the second base portion 50 (FIG. 5D) and is disposed on the second base portion 50. The inner leading portion 64 (FIG. 5E) is disposed between the second base portion 50 and the third base portion 70. The third peripheral portion 71 has the same structure as the second peripheral portion 51 (FIG. 5D) and is disposed on the second peripheral portion 51.

The third beam portions 72a to 72d have the same structure as the second beam portions 52a to 52d (FIG. 5D) and are arranged on the second beam portions 52a to 52d. The inner leading portion 64 (FIG. 5E) is disposed between the second beam portion 52b and the third beam portion 72b. The third hole portions 73a to 73c penetrate the third peripheral portion 71. The third hole portion 73a is formed at a position corresponding to the lower conductive path 68a (FIG. 5E), the third hole portion 73b is formed at a position corresponding with the lower conductive path 68b (FIG. 5E), and the third hole portion 73c is formed at a position corresponding with the inner terminal portion 66 (FIG. 5E).

The base hole portion 74 is formed in a central part of the third base portion 70 and penetrates the third base portion 70. The base hole portion 74 has the same shape as the inner electrode portion 62 (FIG. 5E) and is circular in plan view. The diameter of the base hole portion 74 is smaller than the diameter of the inner electrode portion 62, but may be equal to the diameter of the inner electrode portion 62. At least a part of the inner electrode portion 62 (FIG. 5E) is in contact with the lower surface of the detector 8 (FIG. 5G) via the base hole portion 74.

The shape of the opening edge of the base hole portion 74 is circular in plan view. In FIG. 5F, the opening edge of the base hole portion 74 is illustrated as a perfect circle in a plan view, but may have a shape slightly distorted from a perfect circle. The center position of the base hole portion 74 corresponds with the center position of the inner electrode portion 62. However, the center position of the base hole portion 74 and the center position of the inner electrode portion 62 may be different from each other.

As shown in FIG. 2, the detector 8 is formed on the third insulating film 7 (third base portion 70). The detector 8 of the present embodiment is a thermistor film, which changes heat dissipation characteristics according to the gas concentration in the atmosphere, etc. and changes resistance values according to the change in the heat dissipation characteristics. The detector 8 is manufactured by a known film-forming method. The material constituting the thermistor film is not limited and is, for example, composite metal oxide, amorphous silicon, polysilicon, germanium, or the like.

As shown in FIG. 5G, the detector 8 has a shape corresponding with the third base portion 70 (FIG. 5F). The shape of the detector 8 is square in plan view, but may be circular, oval, oblong, or another polygon. A plurality (four in the example shown in FIG. 5G) of curved portions is formed on the outer edge of the detector 8, but the curved portions may be omitted. The size of the detector 8 is not limited as long as the outer edge of the detector 8 is located outside the outer electrode portion 63 (FIG. 5H).

As shown in FIG. 4, the upper electrode layer 61 is formed on the detector 8, etc. The upper electrode layer 61 constitutes the electrode 6 together with the lower electrode layer 60 described above. The upper electrode layer 61 has a film structure and is manufactured by a known film forming method. As shown in FIG. 5H, the upper electrode layer 61 includes an outer electrode portion 63, an outer leading portion 65, an outer terminal portion 67, and upper conductive paths 69a, 69b, and 69c.

The outer electrode portion 63 is disposed on the detector 8 (FIG. 5G). The detailed structure of the outer electrode portion 63 is described below. The outer leading portion 65 is connected to the outer electrode portion 63. The outer leading portion 65 is led out from the detector 8 (FIG. 5G) and the third base portion 70 (FIG. 5F) to the third peripheral portion 71 via the beam portion 72c (FIG. 5F).

The outer terminal portion 67 is connected to the outer leading portion 65 and is disposed on the third peripheral portion 71. The shape of the outer terminal portion 67 is oblong in plan view, but may be circular, oval, square, another polygonal shape, or the like.

The upper conductive path 69a has the same shape as the lower conductive path 68a (FIG. 5E) and is disposed on the lower conductive path 68a via the third hole 73a (FIG. 5F). The upper conductive path 69a is electrically and physically connected to the lower conductive path 68a. The upper conductive path 69b has the same shape as the lower conductive path 68b (FIG. 5E) and is disposed on the lower conductive path 68b via the third hole portion 73b (FIG. 5F). The upper conductive path 69b is electrically and physically connected to the lower conductive path 68b. The upper conductive path 69c has the same shape as the inner terminal portion 66 (FIG. 5E) and is disposed on the inner terminal portion 66 via the third hole portion 73c (FIG. 5F). The upper conductive path 69c is electrically and physically connected to the inner terminal portion 66.

The terminals 10a to 10d shown in FIG. 5I are formed by a method of, for example, plating, lift-off, metal paste printing, or the like. The material constituting the terminals 10a to 10d is not limited and is, for example, gold, silver, platinum, aluminum, or the like. The terminals 10a to 10c have the same shape as the upper conductive paths 69a to 69c (FIG. 5H), respectively, and are arranged on the upper conductive paths 69a to 69c. The terminals 10a to 10c are electrically and physically connected to the upper conductive paths 69a to 69c, respectively. The terminal 10d has the same shape as the outer terminal portion 67 (FIG. 5H) and is disposed on the outer terminal portion 67. The terminal 10d is electrically and physically connected to the outer terminal portion 67.

The terminals 10a to 10d are each electrically connected to an external circuit (not shown) by, for example, wire bonding. For example, the external circuit supplies electric power via the terminals 10a and 10b. This electric power is transmitted to the heat generation portion 40 (FIG. 5C) via the upper conductive paths 69a and 69b (FIG. 5H), the lower conductive paths 68a and 68b (FIG. 5E), and the heater terminal portions 42a and 42b (FIG. 5C). Also, the external circuit also supplies electric power via the terminals 10c and 10d. This electric power is supplied to the inner electrode portion 62 via the upper conductive path 69c (FIG. 5H) and the inner terminal portion 66 (FIG. 5E) and is also supplied to the outer electrode portion 63 via the outer terminal section 67 (FIG. 5H). Thus, the external circuit obtains an electrical signal reflecting a resistance change of the detector 8.

As shown in FIG. 4, the catalyst 9 is disposed in a central part of the detector 8 so as to be in contact with the detector 8. The catalyst 9 covers the detector 8 and the upper electrode layer 61 (a part of the outer electrode portion 63 and the outer leading portion 65). When a detection target gas (combustible gas) comes into contact with the catalyst 9, a combustion heat is generated due to the catalytic reaction. The detector 8 detects a temperature change due to this combustion heat by its resistance change. The catalyst 9 has a convex shape (dome shape) projecting upward, but the shape of the catalyst 9 is not limited to this. The shape of the catalyst 9 is circular in plan view, but may be oval, quadrilateral, another polygon, or the like.

The catalyst 9 is formed by paste application, heat treatment, or the like. The material constituting the catalyst 9 is not limited and is, for example, a material in which noble metal particles are supported on a carrier. Examples of the carrier include oxide materials such as aluminum oxide (gamma alumina, etc.) and silicon oxide. Examples of the noble metal particles supported on the carrier include noble metal particles of platinum, palladium, ruthenium, rhodium, or the like.

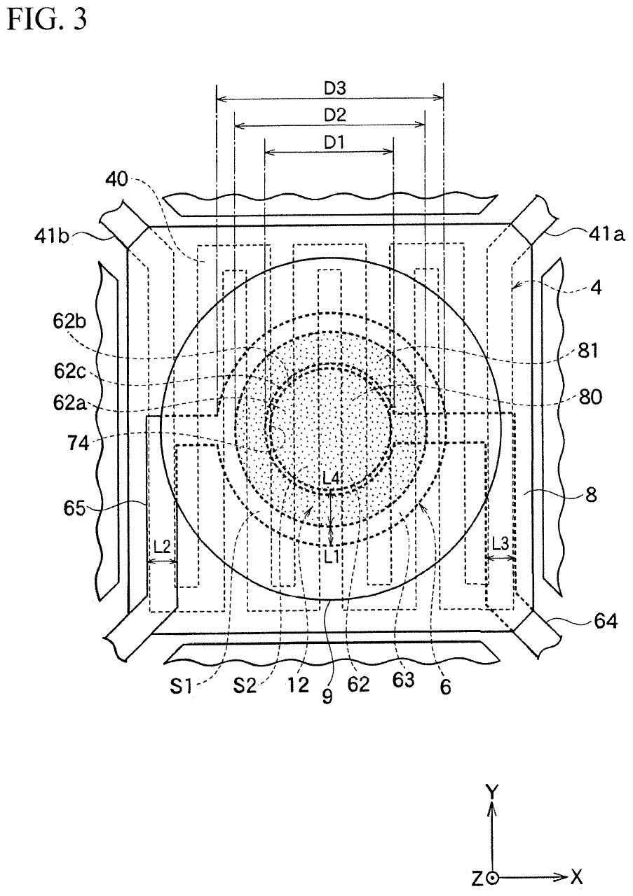

Hereinafter, the structure of a gas detection part 12 is described while referring to the detailed structure of the inner electrode portion 62 and the outer electrode portion 63 described above. As shown in FIG. 3, the gas detection part 12 is disposed on an insulating film (in the present embodiment, the second base portion 50 of the second insulating film 5 shown in FIG. 4) and includes the detector 8, the inner electrode portion 62, and the outer electrode portion 63. The inner electrode portion 62 and the outer electrode portion 63 are in contact with the detector 8. As described above, the inner electrode portion 62 is disposed under the detector 8, and the outer electrode portion 63 is disposed above the detector 8. Also, the inner electrode portion 62 is in contact with the lower surface of the detector 8, and the outer electrode portion 63 is in contact with the upper surface of the detector 8.

The gas detection part 12 is formed in a central part of the second base portion 50 (FIG. 4). In FIG. 3, the region of the gas detection part 12 is indicated by dots. The outer edge (outer circumference) of the gas detection part 12 is along the inner edge (inner circumference) of the outer electrode portion 63. That is, the gas detection part 12 is a region surrounded by the inner edge of the outer electrode portion 63 and is located inside the inner edge of the outer electrode portion 63. However, the region of the gas detection part 12 may include a position on the inner edge of the outer electrode portion 63. The detector 8 is exposed in the gas detection part 12. In this case, however, “exposed” means that the detector 8 is not covered with the insulating film or the electrode 6.

The gas detection part 12 is located above the heat generation portion 40 of the heating part 4 and located inside the outer edge of the heat generation portion 40. Also, the gas detection part 12 is located under the catalyst 9 and is covered with the catalyst 9. The catalyst 9 covers a wider area than the gas detection part 12, and the gas detection part 12 is located inside the outer edge of the catalyst 9 in plan view. The catalyst 9 covers the detector 8, the outer electrode portion 63, etc. The shape of the outer edge of the gas detection part 12 is similar to the shape of the outer edge of the catalyst 9 and is circular in plan view. However, the shape of the outer edge of the gas detection part 12 may be different from the shape of the outer edge of the catalyst 9.

In the gas detection part 12, the detector 8 is sandwiched between the inner electrode portion 62 and the outer electrode portion 63. The inner electrode portion 62 and the outer electrode portion 63 do not face each other along the Z-axis. Thus, the detector 8 is sandwiched between the inner electrode portion 62 and the outer electrode portion 63 in a direction inclined to the Z-axis. Instead, the detector 8 is sandwiched between the inner electrode portion 62 and the outer electrode portion 63 in a planar direction (a direction parallel to the XY plane) in plan view.

The shape of the outer electrode portion 63 is annular (circular or ring-shaped) in plan view. As shown in FIG. 3 and FIG. 5H, both of the inner edge (inner circumference) and the outer edge (outer circumference) of the outer electrode portion 63 are circular in plan view, and the inner edge and the outer edge of the outer electrode portion 63 are arranged concentrically. Thus, a length L1 along the radial direction between the inner edge and the outer edge of the outer electrode portion 63 is constant at any position along the circumferential direction of the outer electrode portion 63. In FIG. 3, both of the inner edge and the outer edge of the outer electrode portion 63 are illustrated as a perfect circle in plan view, but may have a shape slightly distorted from a perfect circle.

The length L1 along the radial direction between the inner edge and the outer edge of the outer electrode portion 63 is smaller than a length L2 of the outer leading portion 65 in a direction perpendicular to its extending direction, but may be equal to or larger than L2.

As described above, since the shape of the outer electrode portion 63 is annular in plan view, the shape of the outer edge of the gas detection part 12 defined by the inner edge of the outer electrode portion 63 is circular in plan view. The outer edge of the gas detection part 12 is illustrated as a perfect circle in plan view, but may have a shape slightly distorted from a perfect circle.

The shape of the inner electrode portion 62 is circular (disc-like) in plan view. In FIG. 3, the inner electrode portion 62 is illustrated as a perfect circle in plan view, but may have a shape slightly distorted from a perfect circle. The inner electrode portion 62 is disposed inside the inner edge of the outer electrode portion 63 and is separated from the outer electrode portion 63 in the radial direction. The outer electrode portion 63 is disposed so as to surround the inner electrode portion 62. As shown in FIG. 5F, the base hole portion 74 is formed in a central part of the third base portion 70. Thus, as shown in FIG. 4, at least a part of the inner electrode portion 62 disposed under the third base portion 70 is exposed from the third base portion 70 via the base hole portion 74. In this case, however, “exposed” means that at least a part of the inner electrode portion 62 disposed under the third base portion 70 is not covered with an insulating film. The distance between the outer edge of the part of the inner electrode portion 62 exposed from the third base portion 70 via the base hole portion 74 and the inner edge of the outer electrode portion 63 corresponds to an electrode width between the inner electrode portion 62 and the outer electrode portion 63.

As shown in FIG. 4, the inner electrode portion 62 includes an exposed portion 62a exposed from the third base portion 70 via the base hole portion 74 and a non-exposed portion 62b covered with the third base portion 70. The exposed portion 62a is in contact with the detector 8, whereas the non-exposed portion 62b is not in contact with the detector 8. The non-exposed portion 62b is located outside the exposed portion 62a in the radial direction (the outer edge of the inner electrode portion 62). Both of the exposed portion 62a and the non-exposed portion 62b are surrounded by the outer electrode portion 63 from the outside in the radial direction. Note that, the outer edge of the inner electrode portion 62 does not need to be covered with the third base portion 70. In this case, the inner electrode portion 62 is not provided with the non-exposed portion 62b and includes only the exposed portion 62a.

As shown in FIG. 3, a diameter D1 of the inner electrode portion 62 is smaller than a diameter D2 of the inner edge of the outer electrode portion 63. However, the diameter D1 of the inner electrode portion 62 may be larger than the diameter D2 of the inner edge of the outer electrode portion 63. Alternatively, the diameter D1 of the inner electrode portion 62 may be larger than a diameter D3 of the outer edge of the outer electrode portion 63. The same applies to the size relation between the diameter of the exposed portion 62a of the inner electrode portion 62 and the diameter D2 of the inner edge of the outer electrode portion 63. The length along the radial direction between the outer edge of the base hole portion 74 formed on the inner electrode portion 62 (the outer edge of the exposed portion 62a) and the inner edge of the outer electrode portion 63 is constant at any position along the circumferential direction of the base hole portion 74.

The diameter D1 of the inner electrode portion 62 is larger than a length L3 of the inner leading portion 64 in a direction perpendicular to its extending direction. The same applies to the diameter of the exposed portion 62a. A distance (inter-electrode distance) LA along the radial direction between the outer edge of the exposed portion 62a and the inner edge (inner circumference) of the outer electrode portion 63 is constant at any position along the circumferential direction of the inner electrode portion 62. For example, as shown in FIG. 4, in a cross section parallel to the XZ plane of the gas sensor 1, L4a and L4b are substantially equal to each other. La is an inter-electrode distance along the X-axis between a position P1a of the outer edge of the exposed portion 62a and a position P2a of the inner edge of the inner edge of the outer electrode portion 63. L4b is an inter-electrode distance along the X-axis between a position P1b of the outer edge of the exposed portion 62a and a position P2b of the inner edge of the outer electrode portion 63. Note that, “substantially” means that an error of ±1% is allowed. Also, as shown in FIG. 3, the distance LA along the radial direction between the outer edge of the exposed portion 62a and the inner edge of the outer electrode portion 63 is not limited and is larger than the length L1 along the radial direction between the inner edge and the outer edge of the outer electrode portion 63.

In plan view, the inner electrode portion 62 and the outer electrode portion 63 are arranged so as not to overlap with each other. In particular, in plan view, the exposed portion 62a and the outer electrode portion 63 are arranged so as not to overlap with each other. Also, a circle defined by the outer edge 62c of the inner electrode portion 62, a circle defined by the outer edge of the exposed portion 62a, a circle defined by the inner edge of the outer electrode portion 63, and a circle defined by the outer edge of the outer electrode portion 63 are arranged concentrically. That is, the center position of the inner electrode portion 62, the center position of the exposed portion 62a, and the center position of the outer electrode portion 63 correspond with each other. However, the center position of the inner electrode portion 62, the center position of the exposed portion 62a, and the center position of the outer electrode portion 63 may be different from each other.

In plan view, the outer edge 62c of the inner electrode portion 62 is opposed to the inner edge of the outer electrode portion 63 in the radial direction. For more detail, the outer edge 62c of the inner electrode portion 62 is opposed to the inner edge of the outer electrode portion 63 in the radial direction in all directions along the entire circumference of the inner electrode portion 62. No matter which direction the electrode 6 is viewed along the entire circumference of the outer electrode portion 63, the electrode pair consisting of the inner electrode portion 62 and the outer electrode portion 63 has the same shape.

In the present embodiment, the outer electrode portion 63 with an annular shape can surround the inner electrode portion 62 (exposed portion 62a) in all directions. Thus, a resistance change of the detector 8 can be output as an electric signal in all directions by the inner electrode portion 62 (exposed portion 62a) and the outer electrode portion 63 surrounding the inner electrode portion 62. This makes it possible to effectively reduce the directional dependence of the detection sensitivity of the gas detection part 12 and significantly improve the detection accuracy and responsiveness of the gas sensor 1.

As shown in FIG. 5E to FIG. 5G, the third base portion 70 of the third insulating film 7 is formed on the inner electrode portion 62, and the detector 8 is formed on the third base portion 70. Here, the base hole portion 74 is formed in a central part of the third base portion 70. Thus, as shown in FIG. 4, the detector 8 is in direct contact with the inner electrode portion 62 (exposed portion 62a) via the base hole portion 74. The diameter of the base hole portion 74 is substantially equal to the diameter D1 of the inner electrode portion 62, and the substantially entire upper surface of the inner electrode portion 62 is in contact with the lower surface of the detector 8. Note that, “substantially” means that an error of ±1% is allowed. The peripheral portion of the base hole portion 74 is stacked on the outer edge of the inner electrode portion 62 so as to cover the outer edge of the inner electrode portion 62, and the non-exposed portion 62b is formed. Thus, in the non-exposed portion 62b, the outer edge of the inner electrode portion 62 and the peripheral portion of the base hole portion 74 overlap with each other. However, the outer edge of the inner electrode portion 62 and the peripheral portion of the base hole portion 74 may be arranged next to each other so as not to overlap with each other.

As shown in FIG. 3 and FIG. 4, the detector 8 is exposed on the inner side (i.e., the gas detection part 12) of the inner edge of the outer electrode portion 63. In this case, however, “exposed” means that the detector 8 is not covered with the insulating film or the electrode 6. As described above, the inner electrode portion 62, which is circular in plan view, is disposed under the detector 8. Thus, the upper surface of the detector 8 is not covered with the inner electrode portion 62 on the inner side of the inner edge of the outer electrode portion 63. Since the surface (upper surface) of the detector 8 is exposed, it is possible to ensure a large detection range of gas concentration by the gas detection part 12. Thus, it is possible to further improve the detection accuracy and responsiveness of the gas sensor 1.

In the gas detection part 12, the detector 8 includes an inner sensing portion 80 located above the exposed portion 62a and an outer sensing portion 81 located between the outer edge of the exposed portion 62a and the inner edge of the outer electrode portion 63. As shown in FIG. 4, the inner sensing portion 80 is disposed on the second insulating film 5 (second base portion 50) via the exposed portion 62a. On the other hand, the outer sensing portion 81 is disposed directly on the third insulating film 7 (third base portion 70). Most of the inner sensing portion 80 is located above the outer sensing portion 81. However, the positional relation between the inner sensing portion 80 and the outer sensing portion 81 is not limited to this. For example, when the thickness of the third base portion 70 is larger than the thickness of the inner electrode portion 62, the upper surface of the outer sensing portion 81 may be disposed above the upper surface of the inner sensing portion 80.

As shown in FIG. 3 and FIG. 4, the shape of the inner sensing portion 80 is defined by the exposed portion 62a and is circular in plan view. The shape of the outer sensing portion 81 is defined by the region between the exposed portion 62a and the outer electrode portion 63 and is annular (circular or ring-shaped) in plan view.

As shown in FIG. 4, a part of the third base portion 70 (the peripheral portion of the base hole portion 74) extends from the second base portion 50 to the outer edge of the inner electrode portion 62 so as to cover the outer edge of the inner electrode portion 62. Also, a part of the outer sensing portion 81 covers the peripheral portion of the base hole portion 74. Thus, a step portion 82 is locally formed in the outer sensing portion 81. Note that, the thickness of the insulating films (third insulating film 7, etc.) or the detector 8 may be adjusted so that the step portion 82 is not formed in the outer sensing portion 81.

The height position of the lower surface of the outer electrode portion 63 (the part that does not overlap with the inner leading portion 64) is equal to the height position of the upper surface of the inner electrode portion 62 (substantially flush). However, the height position of the lower surface of the outer electrode portion 63 may be higher or lower than the height position of the upper surface of the inner electrode portion 62.

As shown in FIG. 3 and FIG. 4, a part of the outer electrode portion 63 intersects with the inner leading portion 64. Thus, the height position at the intersection between the outer electrode portion 63 and the inner leading portion 64 is higher than the height position of other parts of the outer electrode portion 63. At the intersection between the outer electrode portion 63 and the inner leading portion 64, the outer electrode portion 63 and the inner leading portion 64 are insulated by the third base portion 70.

A part of the inner leading portion 64 is led out from the inner electrode portion 62 to one side along the X-axis. Also, a part of the outer leading portion 65 is led out from the outer electrode portion 63 to the other side along the X-axis. That is, the leading direction of the inner leading portion 64 and the leading direction of the outer leading portion 65 are opposite to each other with respect to the X-axis direction. However, these leading directions may be changed as appropriate. Also, another part of the inner leading portion 64 and another part of the outer leading portion 65 are led out in the same direction along the Y-axis. However, these leading directions may be changed as appropriate.

An area S1 of the upper surface or the lower surface of the outer electrode portion 63 is different from an area S2 of the upper surface or the lower surface of the inner electrode portion 62 (moreover, the exposed portion 62a). In the present embodiment, the area S1 of the outer electrode portion 63 is smaller than the area S2 of the inner electrode portion 62 (moreover, the exposed portion 62a). However, the area S1 of the outer electrode portion 63 may be equal to the area S2 of the inner electrode portion 62 (moreover, the exposed portion 62a). Alternatively, the area S1 of the outer electrode portion 63 may be smaller than the area S2 of the inner electrode portion 62 (moreover, the exposed portion 62a).

Next, a method of manufacturing a gas sensor 1 is described. First, a base body (a substrate 2 in which a cavity 20 is not formed) as the basis of a base material 2 shown in FIG. 5A is prepared. Next, each film body shown in FIG. 5B to FIG. 5I is sequentially formed in this order on the upper surface of the base body by a known film forming method. The shape of each film body shown in FIG. 5B to FIG. 5I is formed by, for example, a lift-off method. Next, the bottom surface of the base body is etched until a first base portion 30 (FIG. 5B) of a first insulating film 3 is exposed, and a cavity 20 is formed. As a result, a substrate 2 including the cavity 20 shown in FIG. 5A is formed. Next, as shown in FIG. 3 and FIG. 4, a catalyst 9 shown in FIG. 5J is applied on a detector 8 and an outer electrode portion 63 so that at least a gas detection portion 12 is covered. Accordingly, the gas sensor 1 can be manufactured.

In the present embodiment, as shown in FIG. 3 and FIG. 4, the electrode 6 includes the inner electrode portion 62 and the outer electrode portion 63 disposed so as to surround the inner electrode portion 62 (particularly, the exposed portion 62a). Since the inner electrode portion 62 is surrounded by the outer electrode portion 63, a physical characteristic change of the detector 8 (in the present embodiment, a resistance change of the detector 8) can be uniformly output as an electrical signal from any direction along the circumference of the electrode 6 by the inner electrode portion 62 and the outer electrode portion 63 surrounding the inner electrode portion 62. This makes it possible to reduce the directional dependence of the detection sensitivity of the gas detection part 12 and to detect the gas concentration with high accuracy regardless of the gas concentration distribution or the gas flow direction. In addition, when a thermal fluctuation (thermal distribution) is generated in the gas detection part 12, the gas concentration can be detected with high accuracy without being affected by the thermal fluctuation. Thus, it is possible to obtain a gas sensor 1 with excellent detection accuracy and responsiveness.

Also, the inner electrode portion 62 (particularly, the exposed portion 62a) has a circular shape in plan view. Since the inner electrode portion 62 with a circular shape is surrounded by the outer electrode portion 63, it is possible to obtain a structure in which a change in the resistance of the detector 8 is uniformly output as an electrical signal from any direction along the circumference of the inner electrode portion 62 by the inner electrode portion 62 and the outer electrode portion 63 surrounding the inner electrode portion 62. In particular, since the inner electrode portion 62 with a circular shape is surrounded by the outer electrode portion 63 with an annular shape, a resistance change of the detector 8 can be output as an electrical signal in all directions along the circumference of the inner electrode portion 62 by the inner electrode portion 62 and the outer electrode portion 63 surrounding the inner electrode portion 62. This makes is possible to further reduce the directional dependence of the detection sensitivity of the gas detection part 12 and to further improve the detection accuracy and responsiveness of the gas sensor 1.

Also, at least a part of the detector 8 is located between the inner electrode portion 62 (particularly, the exposed portion 62a) and the outer electrode portion 63 in plan view. Also, the inner electrode portion 62 (particularly, the exposed portion 62a) is in contact with the lower surface of the detector 8, and the outer electrode portion 63 is in contact with the upper surface of the detector 8. Thus, the inner electrode portion 62 and the outer electrode portion 63 are arranged so as to sandwich the detector 8. This makes it possible to output a resistance change of the detector 8 as an electrical signal not only in the plane direction but also in the film thickness direction of the detector 8 (between the upper surface and the lower surface of the detector 8) by the inner electrode portion 62 and the outer electrode portion 63. Thus, it is possible to further reduce the directional dependence of the detection sensitivity of the gas detection part 12 and to further improve the detection accuracy and responsiveness of the gas sensor 1.

### Second Embodiment

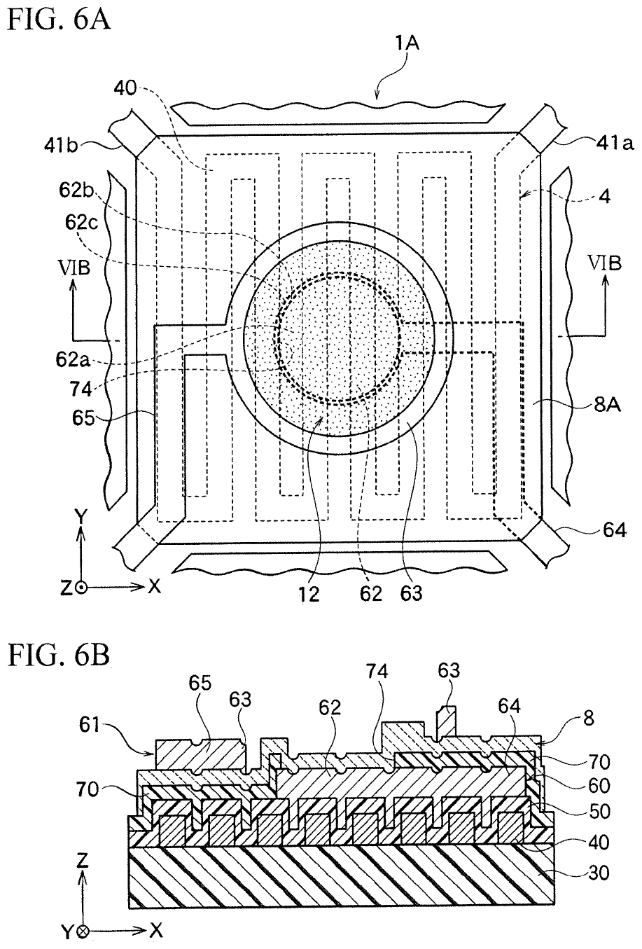

Except for the following matters, a gas sensor 1A of Second Embodiment shown in FIG. 6A and FIG. 6B has the same structures as the gas sensor 1 of First Embodiment. Portions overlapping with those of the gas sensor 1 of First Embodiment are provided with the same reference numerals and are not described in detail.

As shown in FIG. 6A and FIG. 6B, the gas sensor 1A is not provided with the catalyst 9, but a detector (gas sensitive body) 8A is made of a semiconductor (metal oxide semiconductor) film. The material constituting the semiconductor film is not limited and is, for example, tin oxide, zirconium oxide, iron oxide, tungsten oxide, indium oxide, cobalt oxide, or the like. Other structures are similar to those of the gas sensor 1 of First Embodiment.

Also in the present embodiment, effects similar to those in First Embodiment can be obtained. Moreover, in the present embodiment, since the detector 8A is made of a semiconductor film, the gas sensor 1A with a high accuracy and a high reliability can be obtained, particularly in a low concentration region.

### Third Embodiment

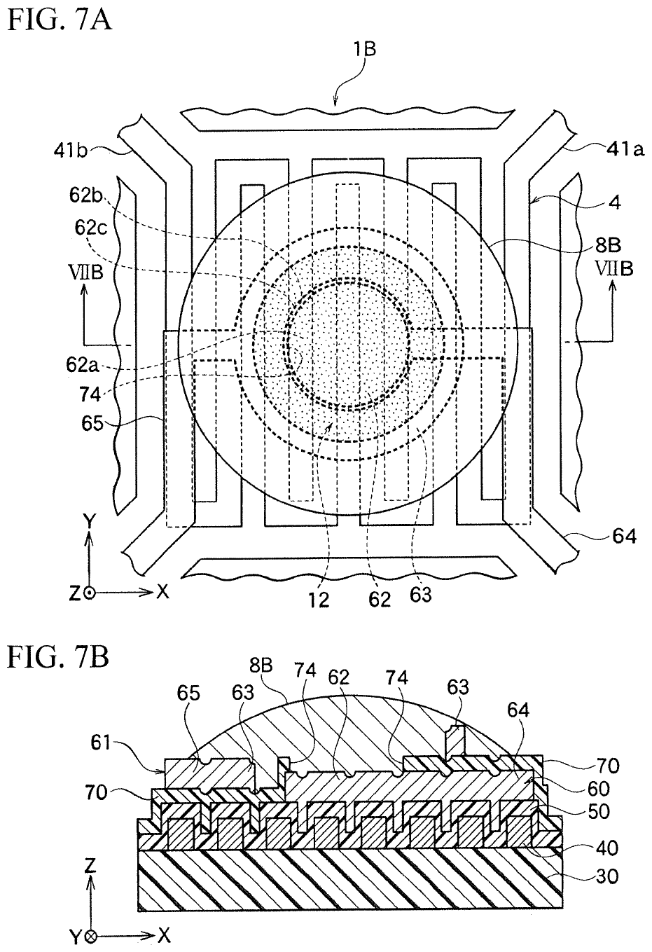

Except for the following matters, a gas sensor 1B of Third Embodiment shown in FIG. 7A and FIG. 7B has the same structures as the gas sensor 1A of Second Embodiment. Portions overlapping with those of the gas sensor 1A of Second Embodiment are provided with the same reference numerals and are not described in detail.

As shown in FIG. 7B, the gas sensor 1B includes a detector (gas sensitive body) 8B. The detector 8B is made of the above-mentioned semiconductor (metal oxide semiconductor) material. The detector 8B is applied on at least the inner electrode portion 62, the outer electrode portion 63, and the third base portion 70 so as to cover them. A part of the detector 8B also extends to a region outside the outer electrode portion 63 in the radial direction, and a part of the outer leading portion 65 is also covered with the detector 8B. However, the region to form the detector 8B is not limited to the region shown in FIG. 7A and FIG. 7B.

The upper electrode layer 61 is formed on the third base portion 70, and the upper electrode layer 61 and the third base portion 70 are in contact with each other. The detector 8B has a convex shape (dome shape) projecting upward, but the shape of the detector 8B is not limited to this. The shape of the detector 8B is circular in plan view, but may be oval, quadrangular, another polygon, or the like.

Also in the present embodiment, effects similar to those in Second Embodiment can be obtained. That is, since the detector 8B is made of an applied semiconductor material, the gas sensor 1B with a high accuracy and a high reliability can be obtained, particularly in a low concentration region.

### Fourth Embodiment

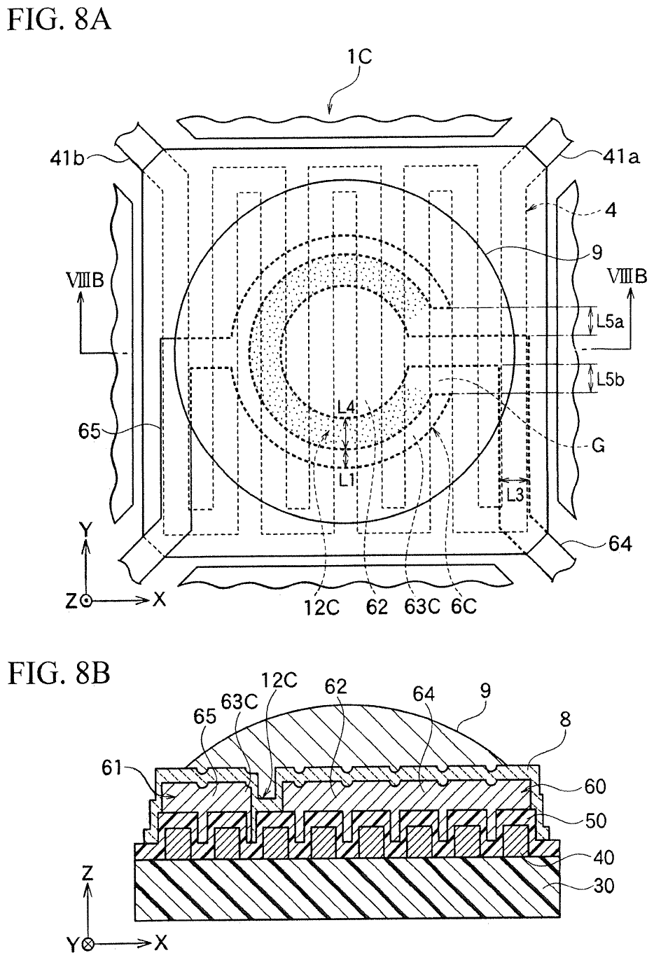

Except for the following matters, a gas sensor 1C of Fourth Embodiment shown in FIG. 8A and FIG. 8B has the same structures as the gas sensor 1 of First Embodiment. Portions overlapping with those of the gas sensor 1 of First Embodiment are provided with the same reference numerals and are not described in detail.

As shown in FIG. 8A, the gas sensor 1C includes an electrode 6C. The electrode 6C includes an outer electrode portion 63C. The shape of the outer electrode portion 63C is an annular shape (C-shape) having a disconnected part in the circumferential direction in plan view. The outer electrode portion 63C extends along the outer edge (outer circumference) of the inner electrode portion 62 and surrounds a part of the inner electrode portion 62. The outer electrode portion 63C is curved (rotated) by 270 degrees or more along the outer edge of the inner electrode portion 62. As long as the outer electrode portion 63C is curved (rotated) by at least 180 degrees along the outer edge of the inner electrode portion 62, however, the degree of curvature (rotation) of the outer electrode portion 63C is not limited.

The radius of curvature of the outer electrode portion 63C is larger than the radius of curvature of the inner electrode portion 62, and the center position of the outer electrode portion 63C corresponds with the center position of the inner electrode portion 62. However, the center of the outer electrode portion 63C may be displaced from the center of the inner electrode portion 62. A length L1 along the radial direction between the inner edge and the outer edge of the outer electrode portion 63C is constant at any position along the circumferential direction of the outer electrode portion 63C.

The inner electrode portion 62 and the outer electrode portion 63C are separated from each other along the radial direction. A distance LA along the radial direction between the inner electrode portion 62 and the outer electrode portion 63C is constant at any position along the circumferential direction of the inner electrode portion 62. In the present embodiment, L4>L1 is satisfied, but similarly to First Embodiment, this size relation may be changed as appropriate.

One end and the other end of the outer electrode portion 63C in its circumferential direction are separated from each other, and a gap G is formed between one end and the other end of the outer electrode portion 63C in its circumferential direction. The inner leading portion 64 is led out from the inner electrode portion 62 along the X-axis so as to pass through the gap G. Thus, the outer electrode portion 63C does not intersect with the inner leading portion 64.

A distance L5a along the Y-axis between the inner leading portion 64 and one end of the outer electrode portion 63C in its extending direction (circumferential direction) is substantially equal to the distance LA along the radial direction between the outer edge of the inner electrode portion 62 and the inner edge of the outer electrode portion 63C. Also, a distance L5b along the Y-axis between the inner leading portion 64 and the other end of the outer electrode portion 63C in its extending direction (circumferential direction) is substantially equal to the distance LA along the radial direction between the outer edge of the inner electrode portion 62 and the inner edge of the outer electrode portion 63C. Note that, “substantially” means that an error of ±1% is allowed.

As shown in FIG. 8B, both of the inner electrode portion 62 and the outer electrode portion 63C are formed on the second base portion 50 of the second insulating film 5. That is, the inner electrode portion 62 and the outer electrode portion 63C are located on the same plane.

Also, both of the inner electrode portion 62 and the outer electrode portion 63C are covered with the detector 8 and are in contact with the lower surface of the detector 8. That is, neither the inner electrode portion 62 nor the outer electrode portion 63C is disposed on the upper surface of the detector 8. Thus, the detector 8 is entirely exposed. In this case, however, “exposed” means that the detector 8 is not covered with the insulating film or the electrode 6C.

A gas detection part 12C is formed between the outer edge of the inner electrode portion 62 and the inner edge of the outer electrode portion 63C and extends along the inner edge of the outer electrode portion 63C. The shape of the gas detection part 12C corresponds with the shape of the outer electrode portion 63C and has an annular shape (C shape) having a disconnected part in the circumferential direction in plan view. The gas detection part 12C is not formed at a position corresponding to the gap G.

Also in the present embodiment, effects similar to those in First Embodiment can be obtained. Moreover, in the present embodiment, the outer electrode portion 63C has an annular shape having a disconnected part in the circumferential direction in plan view. That is, the inner leading portion 64 connected to the inner electrode portion 62 and the outer electrode portion 63C can be arranged on the same plane (on the second base portion 50) without crossing each other, and the manufacturing process of the electrode 6C can be simplified.

### Fifth Embodiment

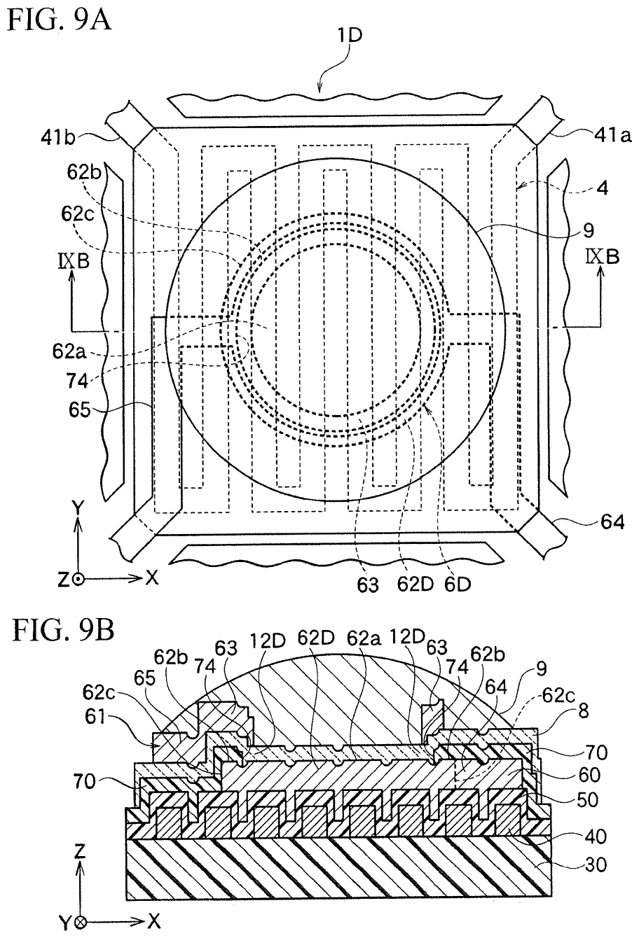

Except for the following matters, a gas sensor 1D of Fifth Embodiment shown in FIG. 9A and FIG. 9B has the same structures as the gas sensor 1 of First Embodiment. Portions overlapping with those of the gas sensor 1 of First Embodiment are provided with the same reference numerals and are not described in detail.

As shown in FIG. 9A, the gas sensor 1D includes an electrode 6D. The electrode 6D includes an inner electrode portion 62D. As is clear from comparison between FIG. 9A and FIG. 3, the area of the inner electrode portion 62D (moreover, the exposed portion 62a) is larger than the area of the inner electrode portion 62 of First Embodiment. The outer edge (outer circumference) of the inner electrode portion 62D is located outside the outer edge (outer circumference) of the outer electrode portion 63. Thus, the outer electrode portion 63 is located inside the inner electrode portion 62D, and a part of the inner electrode portion 62D (the outer edge of the exposed portion 62a) and at least a part of the outer electrode portion 63 overlap with each other in plan view.

As shown in FIG. 9B, a part of the detector 8 is located between the outer electrode portion 63 and the exposed portion 62a and is sandwiched between the outer electrode portion 63 and the exposed portion 62a in the Z-axis direction (in the film thickness direction of the detector 8). The gas detection part 12D is formed by the outer electrode portion 63, the outer edge of the exposed portion 62a, and the detector 8 sandwiched between the outer electrode portion 63 and the outer edge of the exposed portion 62a. That is, the gas detection part 12D is located between the outer electrode portion 63 and the outer edge of the exposed portion 62a in the Z-axis direction and is located at a portion where the outer electrode portion 63 and the exposed portion 62a overlap with each other in plan view.

In the present embodiment, a resistance change of the detector 8 in its film thickness direction (between the top surface and the bottom surface of the detector 8) can be output as an electrical signal by the inner electrode portion 62D (particularly, the exposed portion 62a) and the outer electrode portion 63. Thus, it is possible to further reduce the directional dependence of the detection sensitivity of the gas detection part 12D and to improve the detection accuracy and responsiveness of the gas sensor 1D.

Note that, the present disclosure is not limited to the above-mentioned embodiments and may variously be modified within the scope of the present disclosure. For example, in First Embodiment described above, the inner electrode portion 62 is circular in plan view as shown in FIG. 3, but may be oval, quadrilateral, another polygon, or the like. The same applies to Second Embodiment to Fifth Embodiment described above.

In First Embodiment described above, as shown in FIG. 3, the outer electrode portion 63 is preferably annular in plan view so that the electrode width between the outer electrode portion 63 and the inner electrode portion 62 is a constant distance from any direction, but may be elliptical ring, quadrangular ring, or another polygonal ring. The same applies to Second Embodiment, Third Embodiment, and Fifth Embodiment.

In First Embodiment described above, as shown in FIG. 3, the outer electrode portion 63 extends continuously along its circumferential direction, but may extend intermittently. That is, a part of the outer electrode portion 63 in its circumferential direction may be disconnected at one location. Also, the outer electrode portion 63 may have a shape in which the width (the width along the radial direction between the inner edge and the outer edge of the outer electrode portion 63) varies along the circumferential direction of the outer electrode portion 63. Also, the outer edge and/or inner edge of the outer electrode portion 63 may have an undulating shape. The same applies to Second Embodiment to Fifth Embodiment described above.

In Fourth Embodiment described above, both of the inner electrode portion 62 and the outer electrode portion 63C are arranged under the detector 8. Similarly to First Embodiment, however, the outer electrode portion 63C may be disposed on the detector 8.

The technique shown in Fourth Embodiment (the technique in which the outer electrode portion 63C is formed into an annular shape having a disconnected part in the circumferential direction in plan view) may be applied to Second Embodiment and Third Embodiment described above. Also, the technique shown in Fifth Embodiment (the technique in which the inner electrode portion 62D and the outer electrode portion 63 overlap with each other in plan view) may be applied to Second Embodiment described above.

In First Embodiment described above, the detector 8 is made of a thermistor film or a semiconductor material, but may be made of a Pt wire or the like. The same applies to Second Embodiment to Fifth Embodiment described above.

### Examples

Hereinafter, the present disclosure is described based on more detailed examples, but the present disclosure is not limited to these examples.

### Example

Samples of a gas sensor 1 shown in FIG. 1 and FIG. 2 were manufactured using the following materials. Note that, the diameter of a catalyst 9 in plan view was 150 μm, and the thickness of the catalyst 9 was 20 μm.

### Substrate 2: Si

First Insulating Film 3, Second Insulating Film 5, and Third Insulating Film 7: SiO₂
Heating Part 4: Pt
Electrode 6 (Inner Electrode Portion 62 and Outer Electrode Portion 63): Pt
Detector 8: Co—Ni—Mn-Ox (thermistor film)
Catalyst 9: Al₂O₃ and Pt (material in which Pt was supported on Al₂O₃)
Terminals 10a to 10d: Pt

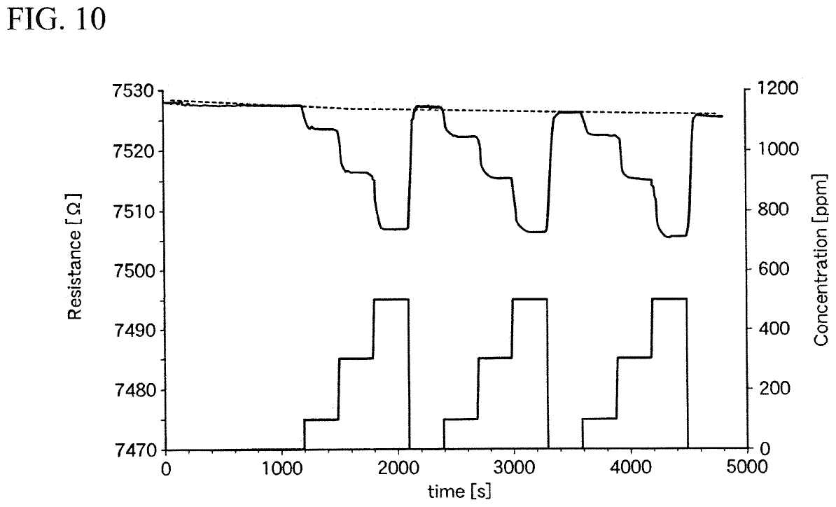

For each of the above-mentioned samples, a response waveform in CO gas detection was obtained. The results are shown in FIG. 10. FIG. 10 shows a concentration change of CO gas supplied to the gas sensor 1 and the response waveform. At a temperature of a gas detection part 12 of 300° C., a treatment was performed three times in which the concentration of CO gas was changed to 100 ppm, 300 ppm, and 500 ppm every 300 seconds.

In the first treatment, the concentration of CO gas was changed from 0 ppm to 100 ppm at an elapsed time of 1200 seconds, the concentration of CO gas was changed from 100 ppm to 300 ppm at an elapsed time of 1500 seconds, and the concentration of CO gas was changed from 300 ppm to 500 ppm at an elapsed time of 1800 seconds. In the second treatment, the concentration of CO gas was changed from 0 ppm to 100 ppm at an elapsed time of 2400 seconds, the concentration of CO gas was changed from 100 ppm to 300 ppm at an elapsed time of 2700 seconds, and the concentration of CO gas was changed from 300 ppm to 500 ppm at an elapsed time of 3000 seconds. In the third treatment, the concentration of CO gas was changed from 0 ppm to 100 ppm at an elapsed time of 3600 seconds, the concentration of CO gas was changed from 100 ppm to 300 ppm at an elapsed time of 3900 seconds, and the concentration of CO gas was changed from 300 ppm to 500 ppm at an elapsed time of 4200 seconds.

### Comparative Example

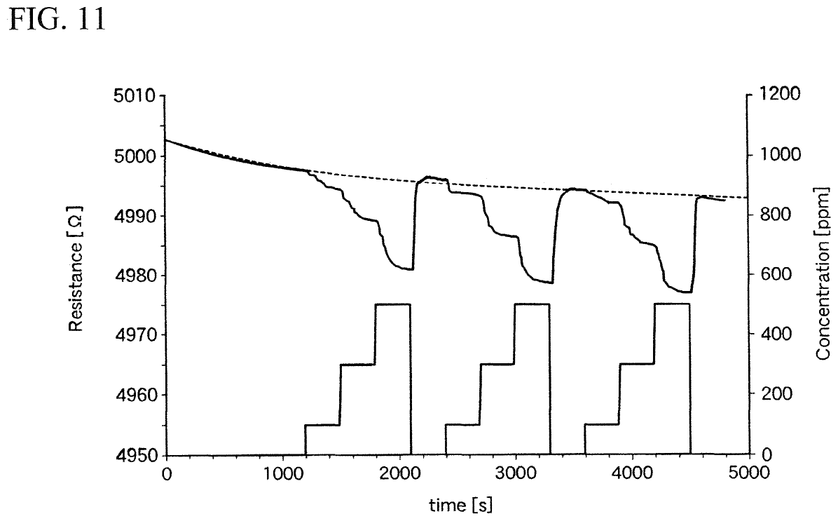

Samples of Comparative Example were prepared using the same materials as in Example. In the samples of Comparative Example, for example, as shown in FIG. 5 of JP6917843 (B2), a pair of electrode portions having an oblong shape in plan view was prepared. Then, the electrode portions were arranged so as to face each other along a direction parallel to each short side of the pair of electrode portions. For each of the above-mentioned samples, a response waveform in CO gas detection was obtained in the same manner as in Example. The results are shown in FIG. 11.

As is clear from comparison between FIG. 10 and FIG. 11, it was confirmed that the variation in the baseline shown by the broken line in FIG. 10 was reduced in Example compared to the variation in the baseline shown by the broken line in FIG. 11 in Comparative Example. It was also confirmed that, in Example, the time required for the detection value to stabilize was shorter, and the saturation response was stable, compared to Comparative Example. It was also confirmed that, the waveform at low concentrations (e.g., 100 ppm) was stable in Examples compared to Comparative Example. These trends were confirmed in all three measurements, and a small variation and a high reproducibility of the response waveform were confirmed.

In Example, the directional dependence of the detection sensitivity of the gas detection part 12 was reduced, and the gas concentration was detected with high accuracy regardless of the gas concentration distribution or the gas flow direction. In addition, the gas detection part 12 was less susceptible to thermal fluctuations (heat distribution), and gas concentration was detected with high accuracy. It is clear from the results shown in FIG. 10 that the above-mentioned effects were obtained in Example.

### DESCRIPTION OF THE REFERENCE NUMERICAL

1, 1A-1D . . . gas sensor
2 . . . substrate
20 . . . cavity
21 . . . top surface
22 . . . bottom surface
23 . . . opening portion
3 . . . first insulating film
30 . . . first base portion
31 . . . first peripheral portion
32a-32d . . . first beam portion
4 . . . heating part
40 . . . heat generation portion
41a, 41b . . . heater leading portion
42a, 42b . . . heater terminal portion
5 . . . second insulating film
50 . . . second base portion
51 . . . second peripheral portion
52a-52d . . . second beam portion
53a, 53b . . . second hole portion
6, 6C, 6D . . . electrode portion
60 . . . lower electrode layer
62, 62D . . . inner electrode portion
62a . . . exposed portion
62b . . . non-exposed portion
64 . . . inner leading portion
66 . . . inner terminal portion
68a, 68b . . . lower conductive path
61 . . . upper electrode layer
63, 63C . . . outer electrode portion
65 . . . outer leading portion
67 . . . outer terminal portion
69a-69c . . . upper conductive path
7 . . . third insulating film
70 . . . third base portion
71 . . . third peripheral portion
72a-72d . . . third beam portion
73a-73c . . . third hole portion
74 . . . base hole portion
8, 8A, 8B . . . detector
80 . . . inner sensitive section
81 . . . outer sensitive section
82 . . . step portion
9 . . . catalyst
10a-10d . . . terminal
12, 12C. 12D . . . gas detection part

What is claimed is:

1. A gas sensor comprising a gas detection part provided on an insulating film, wherein
the gas detection part includes:
a detector; and
an electrode in contact with the detector, and
the electrode includes:
an inner electrode portion; and
an outer electrode portion disposed so as to surround the inner electrode portion.

2. The gas sensor according to claim 1, wherein the outer electrode portion has an annular shape in plan view.

3. The gas sensor according to claim 1, wherein the outer electrode portion has an annular shape in plan view having a disconnected part in a circumferential direction of the outer electrode portion.

4. The gas sensor according to claim 1, wherein the inner electrode portion has a circular shape in plan view.

5. The gas sensor according to claim 1, wherein at least a part of the detector is located between the inner electrode portion and the outer electrode portion.

6. The gas sensor according to claim 1, wherein
the inner electrode portion is in contact with one main surface of the detector, and
the outer electrode portion is in contact with an other main surface of the detector.

7. The gas sensor according to claim 1, wherein the inner electrode portion is located under the detector.

8. The gas sensor according to claim 1, wherein the detector comprises a thermistor film.

9. The gas sensor according to claim 1, wherein the detector comprises a semiconductor film.

10. The gas sensor according to claim 1, wherein the detector is made of a semiconductor material coated on the inner electrode portion and the outer electrode portion so as to cover the inner electrode portion and the outer electrode portion.
